(19) United States
(12) Patent Application Publication
(10) Pub. No.: US 2009/0125328 A1
(43) Pub. Date: May 14, 2009

(54) Method and System For Active Patient Management

(75) Inventor: Sean Michael Nevins, Bryn Mawr, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: AIR PRODUCTS AND CHEMICALS, INC., Allentown, PA (US)

(21) Appl. No.: 11/938,409

(22) Filed: Nov. 12, 2007

(51) Int. Cl. G06Q 10/00; G06F 17/30; G06Q 50/00; G06F 17/40

(52) U.S. Cl. 705/3

(57) ABSTRACT

Methods and systems for active patient management are provided. A central system can receive data about one or more patients from sources such as implantable medical devices within the patient, healthcare providers, pharmacies, and insurance entities. The system may automatically identify anomalous data or trends in the data, and automatically alert a healthcare provider associated with the patient. The alert may provide additional contextual information related to the alert data. Thus, the healthcare provider need not manually analyze patient data on a regular basis. The system also may perform predictive modeling to identify when a patient may need additional healthcare.

### BACKGROUND OF THE INVENTION

The field of disease management includes various approaches for addressing and reducing costs associated with chronic diseases. Typically, disease management strategies are intended to track, reduce, and treat the effects or symptoms of a disease, as opposed to providing a cure for the disease. Exemplary diseases for which disease management strategies are used can include coronary heart disease, congestive heart failure, cancer, diabetes, hypertension, asthma, arthritis, depression, and other common ailments.

A common component of disease management systems is an attempt to reduce or control costs. It has been found that typically 20% of the patients in a chronic population consume about 85% of the available healthcare resources. Thus it is beneficial to identify those patients who will respond well to treatment, those who will result in the highest costs, and other patient populations. Disease management systems also typically attempt to reduce hospitalizations of patients by promoting patient behavior modification.

Conventional disease management systems utilize large call center systems, where nurses talk to managed patients and perform “triage” over the phone. These systems may face difficulties in providing proper care to patients (due to the added layer of care at the call center), in achieving high rates of enrollment and/or compliance from patients, and in successfully encouraging patients to alter their lifestyles. These systems also may use risk stratification to categorize patients based on their expected cost. In this system, each patient is placed in a risk category based on the expected future cost to treat the patient. Typically, the expected cost is projected from previous-year medical costs for the patient, which may not provide an accurate description of future medical costs. As a result, conventional risk stratification systems are only about 30% accurate at predicting costs.

Conventional disease management programs also typically use and provide relatively little information regarding the underlying causes that result in a hospitalization or other treatment being required. For example, if a patient previously was treated using a specific surgery, many conventional disease management programs will only use the cost of the surgery when attempting to place the patient in the proper risk level. In many cases, the system will not take account of the specific procedure performed and/or why the procedure was performed.

In some cases, disease management programs also use implantable medical devices such as pacemakers and other devices. These devices may capture health information about the patient. The patient and/or healthcare providers may use this information to monitor performance of the device. However, each device manufacturer typically has a separate, proprietary interface for accessing the device and information stored by or related to the device. For example, device manufacturers may provide a website that allows patients and/or doctors to view data related to or collected by each device, or to otherwise interface with the device. This can be burdensome for healthcare providers and, to a lesser extent, patients, since it may be necessary to use multiple websites to access the various devices of interest. The devices also typically have limited reporting capability. For example, conventional implantable medical devices and related systems only send a message to an owner or healthcare provider after a value exceeds a pre-set threshold. That is, the device does not perform any thorough analysis of collected data, such as by comparison or combination with other data. In fact, many devices merely identify when certain values occur outside of predetermined boundaries.

### BRIEF DESCRIPTION OF SEVERAL VIEWS OF THE DRAWINGS

FIG. 1 shows an exemplary system and information flow according to the invention.

FIG. 2 shows an exemplary generalized procedure for analyzing patient data according to the invention.

FIG. 3 shows an example of a patient data analysis according to the invention.

FIG. 4 shows exemplary data transfer and processing according to the invention.

FIG. 5 shows an exemplary analysis of patient data according to the invention.

### DETAILED DESCRIPTION OF THE INVENTION

The present invention provides methods and systems for active patient management. A central system can receive data about one or more patients, from, for example, implantable medical devices within the patient, healthcare providers, pharmacies, and insurance entities. As used herein, a “patient” may be any person about and/or from whom data is collected. A patient may have or be at risk of having or developing a health condition that may warrant monitoring, though such condition is not necessary for operation of the invention. Collected patient data can include, for example, healthcare histories, current and historical prescription data, insurance claim information, and physiological data. As used herein, a “patient data source” refers to an aggregate type of data source, such as physiological sensors, medical records, and consumer data reporting sources. Each patient data source may include multiple records or generators of information. For example, “physiological sensors” may include a variety of sensors and monitors. Similarly, “medical records” may include EMR records, physicians' charts, insurance claims, prescription records, and self-reported data. “Consumer data reporting sources” may include a variety of databases, records, and other information, including credit reports, purchasing habits, and other data that may or may not be directly linked to a patient's medical condition or history. “Environmental data” may include other data related to a patient, such as geographic data, weather and atmospheric data, and other ambient information. Other data sources may be used.

The system may automatically identify anomalous data or trends in the data. Once an anomaly is discovered, an alert may be sent to a healthcare provider associated with the patient, such as a primary care physician or other provider. The alert also may be provided to the patient, the patient's family member, a third party, or any other person or entity. General alerts not generated in response to any specific occurrence or situation related to a patient's health also may be provided on demand or at occasional intervals, such as to provide reports on the patient's health.

The alert may be a contextual alert that provides additional information, such as a description of why the alert was generated, a list of factors most affecting the generation and/or content of the alert, and other contextual data. Thus, the healthcare provider need not manually analyze the data for multiple patients on a regular basis, but instead may attend to those patients most in need of assistance or information. The healthcare provider may also be a regular care provider for the patient, which can reduce problems in conventional disease management programs where the first layer of care is provided by someone unfamiliar with the patient's history. The system also may perform predictive modeling to identify when a patient may need additional healthcare, such as a hospital visit. The predictive models may prevent and/or help avoid future hospitalizations.

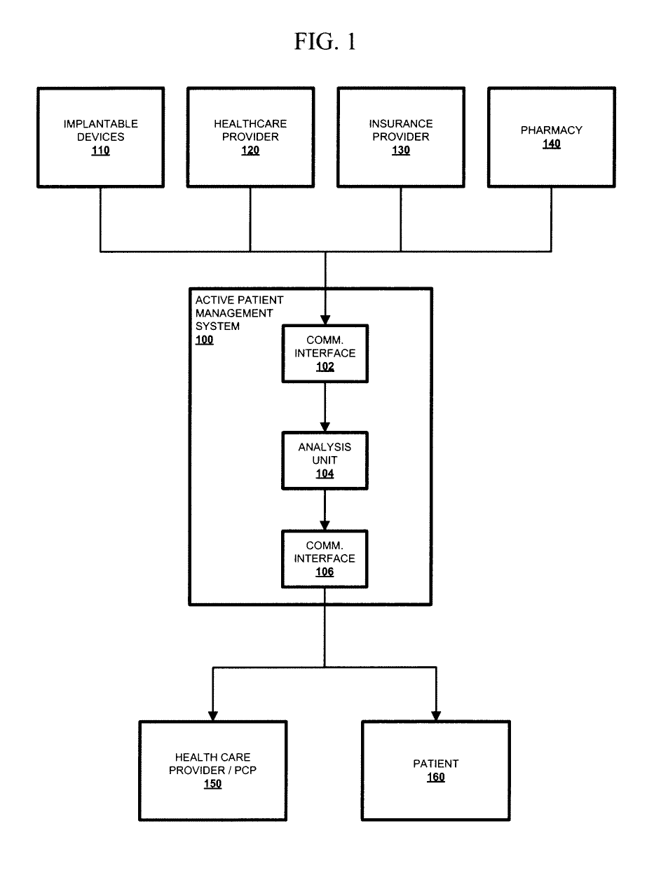

FIG. 1 shows an exemplary system according to the invention. An active patient management system 100 may include one or more communication interfaces 102, 106, and an analysis unit 104. The system may receive data from various data generators, such as implantable medical devices within patients 110, doctors, hospitals, and other healthcare providers 120, insurance entities 130, and pharmacies 140. Although four common patient data sources are illustrated, it will be understood that various other data sources may be used as described herein. The system may collect, aggregate, and analyze various types of data, such as monitoring and performance data from implantable devices, patient history and lab results from healthcare providers, claims data from insurance providers, and current and historical prescription data from pharmacies.

The data may be received by one or more communication interfaces 102. For example, where the system is implemented on one or more general-purpose computers, the data may be received directly, in formats designated by the system and/or the entities providing the data. The data also may be sent by human-readable channels, such as facsimile transmission, e-mail, etc., and converted automatically or by human intervention to a format suitable for further processing.

An analysis unit 104 may combine and analyze the received data. A variety of analysis mechanisms and algorithms may be used to detect anomalous data and/or patterns in the received data. As a specific example, data received from a pacemaker may be analyzed to identify any anomalous readings, performance issues, or patterns in data collected by the pacemaker. As another specific example, the analysis unit might automatically identify increasing frequency of arterial fibrillation episodes. In addition, the system may extract related information, such as the status of the battery, whether the pacemaker took any pre-programmed actions based on the detected anomaly, the status and reliability of the pacemaker's communication to an outside system, and other data. In contrast, conventional systems merely report minimal data directly collected by the pacemaker, and do not perform any analysis.

In some cases, the analysis unit 104 may perform predictive modeling using the received data and/or historical data for the same patient. As a specific example, if the system identifies an increased frequency of arterial fibrillation episodes, the system may analyze the episodes and, combined with a known diagnosis of congestive heart failure, predict the possibility of a future CHF-related hospitalization. The predictors of such a hospitalization (CHF combined with increasing arterial fibrillation) may be communicated to healthcare providers in an alert. The alert may include a corresponding recommended action, such as prescribing anti-arrhythmic medication. This analysis and reporting may reduce hospitalization risk and improve patient outcomes. A predictive model also may be used to generate a risk index as described herein.

The alert also may be a contextual alert. As used herein, a contextual alert refers to an alert that provides an indication of one or more causal factors that contributes to the other content of the alert and/or that caused the alert to be sent. For example, a contextual alert that includes a risk index as described herein also may indicate the primary contributor to the risk index. As a specific example, a contextual alert indicating the possibility of a future CHF-related hospitalization may be generated as described above. As a specific example, the contextual alert may be generated due to three factors identified by the system: an increased frequency of arterial fibrillation episodes, a decrease in the rate of anti-arrhythmic prescription refills, and records of a previous diagnosis of congestive heart failure. Thus, the causal factors contributing to the alert are an increased frequency of fibrillation episodes, a probable decreased intake of anti-arrhythmic medication, and a previous CHF diagnosis. The contextual alert, therefore, may list one or more of these causal factors as contributing to the predictive content of the alert (i.e., the likelihood of a CHF-related hospitalization). As a further example, if one of the three factors was more responsible for the generation of the alert than the others, it may be identified as a primary contributor to the alert.

As further specific, non-limiting examples, the system may generate an alert when an incorrect and/or contraindicated medication is prescribed or dispensed (such as by comparing claim or prescription data with diagnosis information), or when two drugs with potentially adverse interactions are prescribed (by analyzing pharmacy and/or prescription data). The alerts may be contextual alerts that include additional information such as an indication of the conflict between claim/prescription data and diagnosis information that suggests an incorrect and/or contraindicated medication was prescribed or dispensed. As a specific example, if a patient having a bronchoplastic disease, such as asthma, is prescribed a beta blocker as part of a CHF therapy by a healthcare provider who is unaware of the bronchoplastic condition, a high potential for serious side effects may result. Therefore, a system according to the present invention may generate a contextual alert upon identifying the presence of the condition and the new prescription.

The system may include data sources not typically associated with medical diagnosis and treatment when generating alerts and contextual alerts. For example, where a patient has indicated an increased discomfort from asthma, a contextual alert may include information describing atmospheric, pollutant, and/or allergen conditions. Such data may provide context to other data, a diagnosis or a suggested treatment in the alert since they describe factors that can cause aggravated asthma symptoms.

The data may be provided regularly and/or in batches. For data sources that are not expected to change very frequently, data may be provided in relatively infrequent batches, such as weekly or monthly. The frequency of updates may be determined for each patient data source, and/or each data generator included in each patient data source. More dynamic data may be provided more often, such as daily or hourly. For example, implantable medical devices may be configured to provide data hourly, while patient charts may be updated less frequently. Table I shows exemplary data sources and the types of data that may be provided.

TABLE I

| Data Type | Data Source(s) |
|---|---|
| Implanted device data (ICD, | Device manufacturers' remote monitoring |
| CRT-D) | systems; electrophysiologist offices |
| Claims/authorizations | Payers |
| Pharmacy/prescription data | Payers, PBMs |
| Lab reports | Laboratories, hospitals |
| Medical records | Hospitals, primary care physicians, EMRs, |
| | automated medical record systems |
| Environmental data | Public records, subscription services |

The system also may calculate one or more risk indices. A risk index provides a probability that an adverse event will occur within a given time or due to a specified condition. For example, a risk index may be stated as “a 30% chance that the patient will require a hospital visit in the next 30 days,” or “a 25% chance that the patient will have an adverse reaction to a proposed medication.” As another example, after detection of an anomalous event, the risk index may be stated relative to the event, such as “70% chance the patient will require a hospital visit in the next 30 days if the anomalous event occurs more often than once a day.” Other variations and features may be used. In some cases, the risk index may be used by the system to set the importance or urgency of an alert or information provided to the patient or a healthcare provider. For example, if the risk index for a hospital visit is above a certain threshold, the system may designate a communication to a healthcare provider as a critical alert. Contributors to the risk index may be used by care providers to reduce the risk of the predicted hospitalization.

A contextual alert may include a risk index and an indication of one or more causal factors contributing to the risk index. For example, in addition to indicating the chance of an adverse reaction to a proposed medication, a contextual alert may indicate that the patient's family medical history indicates a propensity for the adverse reaction. Thus, the contextual alert may provide a healthcare provider with contextual information about the information in the alert and/or the reason for sending the alert. In some cases, there may be multiple causal factors contributing to the content and/or generation of an alert. The contextual alert may present a subset of all the relevant factors, or it may present all the factors. Where one of the causal factors is a primary contributor to the alert, the contextual alert may so indicate. As a specific example, a prediction of an adverse event generated by a predictive model may result from consideration of four factors. The contextual alert may indicate that one of the factors was given more weight by the predictive model, or is more directly responsible for the prediction. This factor may be presented as a primary contributor to the alert and/or the risk index. Other relationships between causal factors may be included in the contextual alert. Thus, in contrast to conventional patient management messages that merely indicate when a monitored value is out of range or that a specific event has taken place, a contextual alert may provide a healthcare provider with additional information that can be utilized to more accurately treat a disease.

The algorithms used to identify anomalies in the received data may be linked to or based on workflows and decision charts specific to a healthcare provider associated with the patient. For example, the patient's primary care physician may specify data items and ranges that, if identified by the system, should result in an alert being sent to the provider.

In some cases, routine (i.e., non-anomalous) data may be stored for future use in analyzing newly-received data. In many configurations routine data is not provided to healthcare providers, to reduce the amount of data the provider must analyze to determine an appropriate treatment for the patient. For example, if a patient is being monitored for a specific symptom, routine data that is unrelated to the ailment may be discarded. As a specific example, when a patient is being monitored for the occurrence of high blood pressure, routine data describing the patient's (unrelated) allergy prescription may be discarded.

After the system has analyzed the data, it may provide one or more alerts to a health care provider, such as a primary care physician of the patient. An alert may be a routine update regarding the patient's status, such as a page to be added to the patient's chart, or it may be a specific notification of an issue that should be addressed by the healthcare provider and/or the patient. The alert may be a contextual alert as previously described. The system also may provide information to the patient, which may be the same as or different from the information sent to the healthcare provider.

The system also may allow for a healthcare provider to send new configuration data and/or other instructions to an implantable medical device associated with an alert. For example, a system according to the invention may send a contextual alert indicating that an implantable medical device has recorded data exceeding a predefined threshold but that, in view of other patient data, it is likely that the device is mis-calibrated and the readings do not indicate a high likelihood of an adverse event. The system may elicit new configuration data from a healthcare provider, which may then be sent to the device to reconfigure the device.

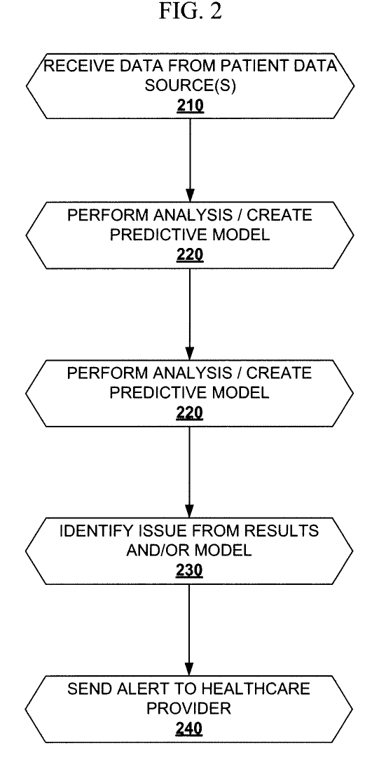

FIG. 2 shows an exemplary generalized procedure according to the invention. Data describing the condition of a patient may be received from one or more patient data sources 210. The system may analyze the data, for example to identify correlations and/or causation chains, and to apply stored rules or guidelines to the data. The analysis may include creation of a predictive model. Results of the analysis may be compared to stored thresholds, trends, and/or guidelines, or otherwise examined for the existence of an adverse or otherwise noteworthy event or condition 230. If the results and/or predictive model indicate an increased risk of hospitalization, a risk of an adverse event, or other issue requiring attention of a healthcare provider, the system may send an alert to a healthcare provider summarizing the identified issue 240, and/or providing additional contextual information as previously described.

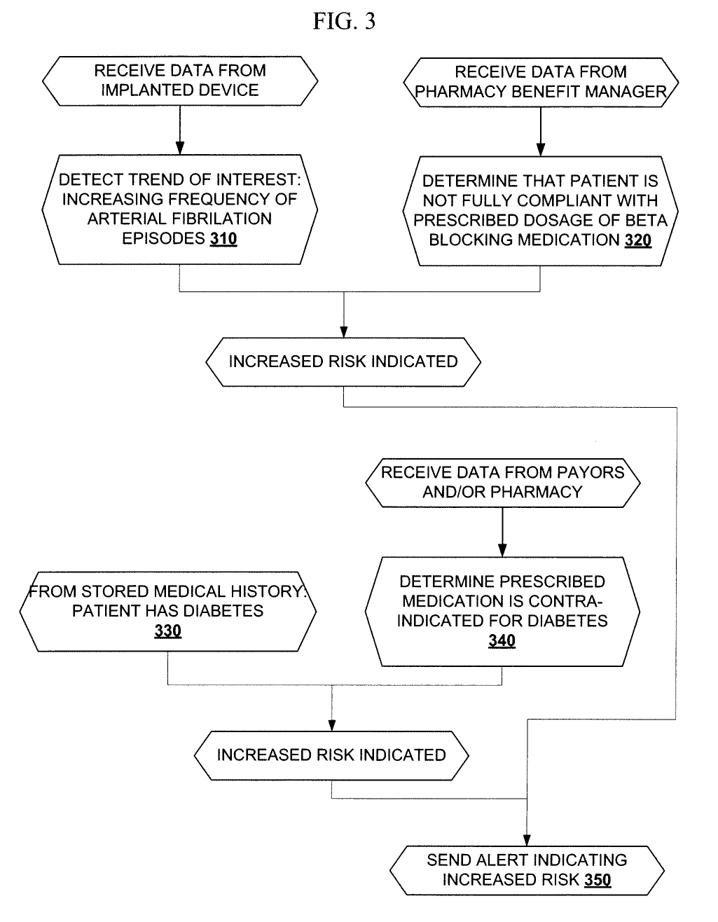

FIG. 3 shows a specific, non-limiting example of a patient data analysis according to the invention. A system 300 may detect a data item or trend of interest, such as an increasing frequency of arterial fibrillation episodes based on raw data from an implanted medical device 310. The system also may contain data from a pharmacy benefit manager that indicates when the patient's beta-blocking medication has been refilled. The system may analyze the data and determine that the patient has not fully complied with the prescribed dosage requirements of the medication 320. From the patient's medical history, the system may determine that the patient has previously been diagnosed with diabetes 330. The system also may analyze payor claims data and pharmacy data to determine that the patient has been prescribed a medication that is contra-indicated for insulin-dependent patients 340. The system may combine these various factors to determine that the patient has an increased risk for hospitalization. For example, the system may determine that the patient has a 55% chance of hospitalization in the next 3 months. The system may send an alert to a care provider 350, which may include the specific factors, probabilities, and other results calculated by the system. The alert also may suggest potential steps to reduce risk, such as prescribing anti-arrhythmic medications, changing the contra-indicated medication for one supported by diabetic patients, and/or asking the patient why the beta blockers are not being used. In the example shown in FIG. 3, an alert also may be generated and sent at any point that an increased risk of hospitalization or an adverse event or condition is detected. For example, an alert may be sent based only on the combination of the stored medical history and prescription of a contra-indicated medication.

As another specific, non-limiting example, the system may detect an increase in a patient's transthoracic impedance using data collected from an ICD with appropriate sensors. The system also may store or have access to data indicating that the patient is also on CPAP. Normally, an increased transthoracic impedance would indicate an increased risk of hospitalization. However, CPAP typically distorts transthoracic impedance averages, which may suggest that the patient is not at an increased risk. The system may send a contextual alert that identifies the increased transthoracic impedance, but indicates a low risk of hospitalization due to the use of CPAP. The contextual alert also may briefly describe the typical effect of CPAP on transthracic impedance averages. As shown by this example, the systems and methods disclosed herein may allow a physician not to manually monitor sensor readings on a regular basis, since such readings are analyzed in combination with other patient medical information.

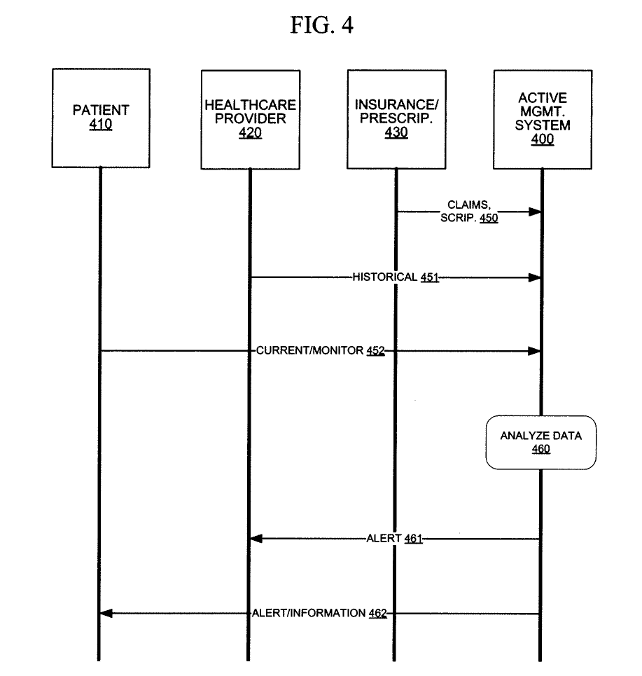

FIG. 4 shows exemplary data transfer to and from an active patient management system 400 according to the invention. As previously described, various entities may provide data to the system. These entities may include the patient and/or implanted medical devices 410, one or more healthcare providers 420, and insurance and prescription providers 430. Although shown occurring in order for clarity, it will be understood that each entity may provide data at any time, independent of each other entity. Insurance/prescription providers may send claims data and prescription information 450. A healthcare provider may send historical and/or current patient data 451, and the patient and/or an implanted medical device may provide current and/or monitored data 452 regarding the patient's condition. As previously described, the management system may summarize and/or analyze the received data, such as to identify anomalous data or events 460. The analysis also may include creating a predictive model. If an anomaly is detected or the predictive model indicates the possibility of an adverse event or condition, the system may send an alert to a healthcare provider associated with the patient 461. The system also may provide various information, such as summary or update data to the patient 462.

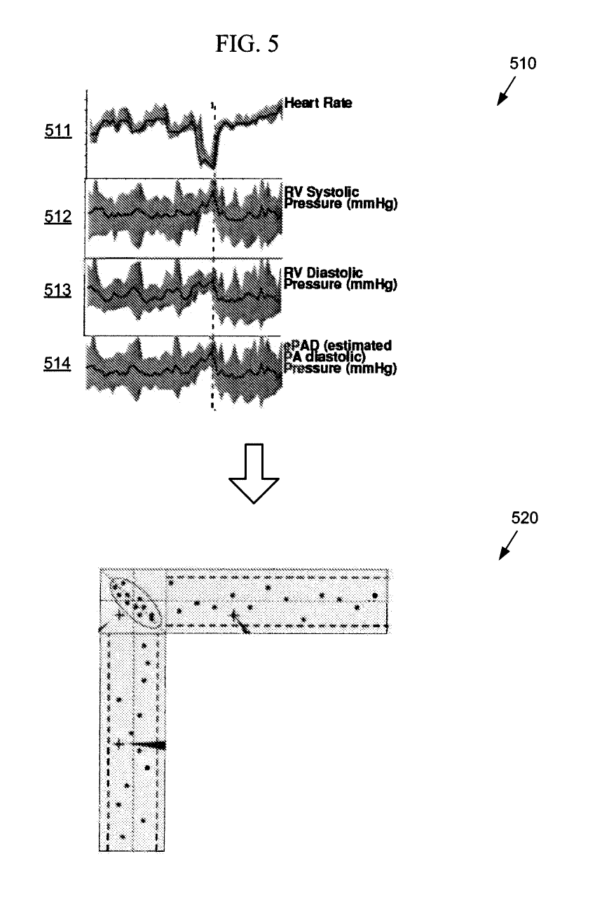

FIG. 5 shows an exemplary analysis of patient data according to the invention. It will be understood that the system described herein can perform various analyses, and those specifically described are provided as non-limiting examples. In FIG. 5, data 510 received by an active patient management system includes a patient's heart rate 511, RV systolic blood pressure 512, RV diastolic blood pressure 513, and estimated PA diastolic blood pressure 514. An active management system according to the invention may collect and analyze this data using a multivariate analysis 520. In the example shown, each data point provided may or may not be individually outside of normal ranges expected for the patient. However, when taken together in context, a multivariate analysis may illustrate that the overall normal range for the patient has been breached. When the anomaly is identified, an alert may be sent to healthcare providers associated with the patient. A contextual alert also may briefly identify and/or describe the multivariate model resulting in the alert. For example, the contextual alert may include a list or description of one or more of the primary variables 511, 512, 513, 514, and indicate how each listed variable contributes to a combined variable in the multivariate model. The contextual alert may indicate or summarize the mathematical contribution of a primary variable, or it may provide a descriptive indication of the relationship between the variable and the multivariate model.

The various systems described herein may each include a computer-readable storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms. The various communications and operations described herein may be performed using any encrypted or unencrypted channel, and storage mechanisms described herein may use any storage and/or encryption mechanism.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

1. A method comprising:
receiving data describing a patient's health condition from multiple patient data sources;
performing an analysis of the received data, the analysis using data from multiple patient data sources; and
providing a contextual alert to a healthcare provider in response to a result of the analysis, the contextual alert comprising an indication of a causal factor contributing to the alert.

2. The method of claim 1, wherein the performing an analysis of the received data includes identifying a potentially adverse event.

3. The method of claim 1, wherein the contextual alert includes a risk index.

4. The method of claim 3, wherein the causal factor is a primary contributor to the value of the risk index.

5. The method of claim 3, wherein the risk index indicates the likelihood that the patient will require hospitalization.

6. The method of claim 1, further comprising:
responsive to instruction received from the healthcare provider, sending new configuration data to a medical device associated with the patient.

7. A computer-readable storage medium storing a plurality of instructions which, when executed by a processor, cause the processor to perform a method comprising:
receiving data describing a patient's health condition from multiple patient data sources;
performing an analysis of the received data, the analysis using data from multiple patient data sources; and
providing a contextual alert to a healthcare provider in response to a result of the analysis, the contextual alert comprising an indication of a causal factor contributing to the alert.

8. The computer-readable storage medium of claim 7, wherein the performing an analysis of the received data includes identifying a potentially adverse event.

9. The computer-readable storage medium of claim 7, wherein the contextual alert includes a risk index.

10. The computer-readable storage medium of claim 9, wherein the causal factor is a primary contributor to the value of the risk index.

11. The computer-readable storage medium of claim 9, wherein the risk index indicates the likelihood that the patient will require hospitalization.

12. The computer-readable storage medium of claim 7, further comprising:
responsive to instruction received from the healthcare provider, sending new configuration data to a medical device associated with the patient.

13. A method comprising:
receiving data describing a patient's health condition;
creating a predictive model of the patient's condition based on the received data; and
providing a contextual alert to a healthcare provider in response to a prediction of the predictive model, the contextual alert comprising an indication of a causal factor contributing to the alert.

14. The method of claim 13, wherein the alert includes a risk index.

15. The method of claim 14, wherein the risk index indicates the likelihood that the patient will require hospitalization.

16. The method of claim 14, wherein the causal factor is a primary contributor to the value of the risk index.

17. A computer-readable storage medium storing a plurality of instructions which, when executed by a processor, cause the processor to perform a method comprising:
receiving data describing a patient's health condition;
creating a predictive model of the patient's condition based on the received data; and
providing a contextual alert to a healthcare provider in response to a prediction of the predictive model, the contextual alert comprising an indication of a causal factor contributing to the alert.

18. The computer-readable storage medium of claim 17, wherein the alert includes a risk index.

19. The computer-readable storage medium of claim 18, wherein the risk index indicates the likelihood that the patient will require hospitalization.

20. The computer-readable storage medium of claim 18, wherein the causal factor is a primary contributor to the value of the risk index.

21. A system comprising:
a receiving unit to receive data describing a health condition of a patient from multiple patient data sources;
an analyzer to analyze the data received by the receiving unit and to compare results of the analysis to a set of conditions defining when a contextual alert should be sent, the contextual alert comprising an indication of a causal factor contributing to the alert; and
a communication output to send the contextual alert to a healthcare provider.

22. The system of claim 21, wherein the alert includes a risk index, and the causal factor is a primary contributor to the value of the risk index.

23. The system of claim 21, further comprising a communication link adapted to send new configuration data to a medical device associated with the patient.

24. The system of claim 21, the analyzer further to construct a predictive model based on the received data, the predictive model specifying the conditions defining when the contextual alert should be sent.

25. The system of claim 24, wherein the alert includes a risk index, and the causal factor is a primary contributor to the value of the risk index.
